(19) United States
(12) Patent Application Publication
(10) Pub. No.: US 2002/0049826 A1
(43) Pub. Date: Apr. 25, 2002

(54) Object distributing system, portable terminal and server used therefor, and memory management method

(75) Inventor: Kenichi Ariga, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/971,491

(22) Filed: Oct. 5, 2001

(30) Foreign Application Priority Data
Oct. 11, 2000 (JP) 310006/2000

(51) Int. Cl. G06F 15/167

(52) U.S. Cl. 709/216; 711/154

(57) ABSTRACT

An object distribution system can obtain memory without causing wasteful distribution or requiring erasure of memory by user and a memory management method in a portable terminal. The object distribution system includes a portable terminal and a server for distributing an object to the portable terminal connected by a network. The portable terminal includes a storage medium for storing the object, detecting means for detecting a remaining capacity of the storage medium becoming less than or equal to a preliminarily set threshold value, and transmitting means for transmitting a message for notifying a memory full condition of the storage medium to the server when the detecting means detects the remaining capacity of the storage medium becoming less than or equal to the threshold value.

### BACKGROUND OF THE INVENTION

1. Field of the Invention

The present invention relates generally to an object distributing system, a portable terminal and a server to be used therefor, and a management method thereof. More particularly, the invention relates to a memory management method accumulating data distributed from the server.

2. Description of Related Art

In the recent years, according to spreading of internet, a potable terminal for internet access in a mobile environment has been used frequently. Data to be received by the portable terminal may be electronic mails, WEB data and so forth. According to getting higher performance and speeding up of communication speed, data capacity tends to be increased.

On the other hand, concerning data communication method, not only reception of data from a server in response to trigger from the portable terminal, but also data distribution for the portable terminals in response to trigger from the server, so called PUSH communication are performed.

In the foregoing conventional portable terminal, since a storage device is constructed with a semiconductor, storage capacity is limited in comparison with note type personal computers or the like. When the storage capacity of the storage device becomes full, new data cannot be received unless storage data in the storage device is erased by user or designation permitting over-writing is set.

On the other hand, when data distribution is performed in response to trigger from the server, remaining capacity of the storage device of the portable terminal to which data are distributed is unknown. Therefore, as a result of distribution, capacity of storage device possibly becomes full to cause failure of transmission from the server.

In connection with two problems set forth above, discussion will be given with reference to FIG. 12. In FIG. 12, the portable terminal 6 has a construction for receiving object, such as E-mail (electronic mail) or the like from a distribution server 7 via a network (NW) 100.

Now, the portable terminal has a memory 8a therein, capacity of which memory 8a is in a condition close to full (near full condition) (S81 of FIG. 12). In this condition, even if an object for distributing from the distribution server 7 to the portable terminal 6 is present (S82 of FIG. 12), since condition of the portable terminal 6 is unknown from the distribution server 7, object is transmitted (S83 of FIG. 12).

When memory overflow is caused in the condition receiving object (S84 of FIG. 12) (at this time, the memory 8b in the portable terminal 6 is full condition), the portable terminal 6 cannot receive any further data. Therefore, even when the object transmission is performed from the distribution server 7 (S85 of FIG. 12), reception error is caused. Subsequently, unless user erases memory of the portable terminal 6 (memory 8b to memory 8c), object from the distribution server 7 cannot be received.

### SUMMARY OF THE INVENTION

Therefore, the present invention has been worked out for solving the problems set forth above. It is an object of the present invention to provide an object distributing system and a memory management method in a portable terminal which can obtain memory without wasteful distribution or erasure of memory by user.

According to the first aspect of the present invention, an object distribution system, in which a portable terminal and a server for distributing an object to the portable terminal, are connected by a network, the portable terminal comprises:

a storage medium for storing the object; detecting means for detecting a remaining capacity of the storage medium becoming less than or equal to a preliminarily set threshold value; and transmitting means for transmitting a message for notifying a memory full condition of the storage medium to the server when the detecting means detects the remaining capacity of the storage medium becoming less than or equal to the threshold value.

According to the second aspect of the present invention, a memory management method in a portable terminal in an object distribution system, in which a portable terminal and a server for distributing an object to the portable terminal, are connected by a network, the method comprising:

step of detecting a remaining capacity of a storage medium for storing the object, becoming less than or equal to a preliminarily set threshold value; and

step of transmitting a message for notifying a memory full condition of the storage medium to the server when the detecting means detects the remaining capacity of the storage medium becoming less than or equal to the threshold value.

According to the third aspect of the present invention, a portable terminal to be connected to a server for distributing an object through a network, comprising:

a storage medium for storing the object;

detecting means for detecting a remaining capacity of the storage medium becoming less than or equal to a preliminarily set threshold value; and

transmitting means for transmitting a message for notifying a memory full condition of the storage medium to the server when the detecting means detects the remaining capacity of the storage medium becoming less than or equal to the threshold value.

According to the fourth aspect of the present invention, a server connected to a portable terminal through a network for distributing an object, comprising:

means for receiving a message notifying a memory full condition of a storage medium for storing the object, from the portable terminal and notifying a demand message promoting capacity acquisition of the storage medium for the portable terminal upon holding a preferential object to be preferentially transmitted to the portable terminal.

Namely, in the memory management method in the portable terminal according to the present invention, when the memory for receiving object in the portable terminal is full or near full condition and if the object to be preferentially transmitted is present on the side of the server, the demand for acquisition of capacity is noticed from the distribution server to the portable terminal, and in response to this notice, objects stored in the memory currently is selectively and temporarily uploaded to the server or is erased.

More particularly, in the memory management method in the portable terminal according to the present invention, when the capacity of the storage medium, such as memory built in or external is in a condition near full, the memory full notice is transmitted to the distribution server.

At this timing, if the object to be preferentially transmitted, acquisition of the memory capacity is transmitted the capacity acquisition demand is promoted. In the portable terminal, when the message is received, measure to be taken is selected between erasure or upload and the object to be erased or uploaded is selected. When selection is completed, in the portable terminal, upon uploading, the selected object is transmitted to the distribution server.

When transmission in the portable terminal is completed, the capacity acquisition completion notice message is transmitted. The distribution server recognizes that vacant capacity is acquired in the transmission memory in the portable terminal, the object to be given preference is transmitted to the portable terminal,

Thus, by demanding the portable terminal from the distribution server to acquire memory necessary for distributing in the present invention, acquisition of the capacity is performed in the portable terminal. Even when the object to be preferentially transmitted is present, the distribution server may transmit the object to the portable terminal.

When the portable terminal becomes near full condition, the fact is notified to the distribution server. Upon transmitting the server object, by notifying necessary capacity to the portable terminal in advance, waste distribution becomes unnecessary. On the other hand, for avoiding that the user is inherently required to erase the content of memory for receiving important object, the object stored in the memory is temporarily uploaded to the server to acquire the memory capacity necessary for reception of the preferential object without loss of stored objects.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a sequence chart showing operation of the first embodiment of an object distribution system according to the present invention;

FIG. 2 is a block diagram showing a construction of a portable terminal of FIG. 1;

FIG. 3 is a flowchart showing process operation of the portable terminal of FIG. 1;

FIG. 4 is a flowchart showing process operation of the portable terminal of FIG. 1;

FIG. 5 is a flowchart showing process operation of a distribution server of FIG. 1;

FIG. 6 is a flowchart showing process operation of a distribution server of FIG. 1;

FIG. 7 is an illustration showing a display screen of a portable terminal of FIG. 1;

FIG. 8 is an illustration showing a display screen of a portable terminal of FIG. 1;

FIG. 9 is an illustration showing a display screen of a portable terminal of FIG. 1;

FIG. 10 is a sequence chart showing operation of the second embodiment of an object distribution system according to the present invention;

FIG. 11 is an illustration showing a list of data for uploading the distribution server of FIG. 1;

FIG. 12 is a sequence chart showing operation of the conventional object distribution system.

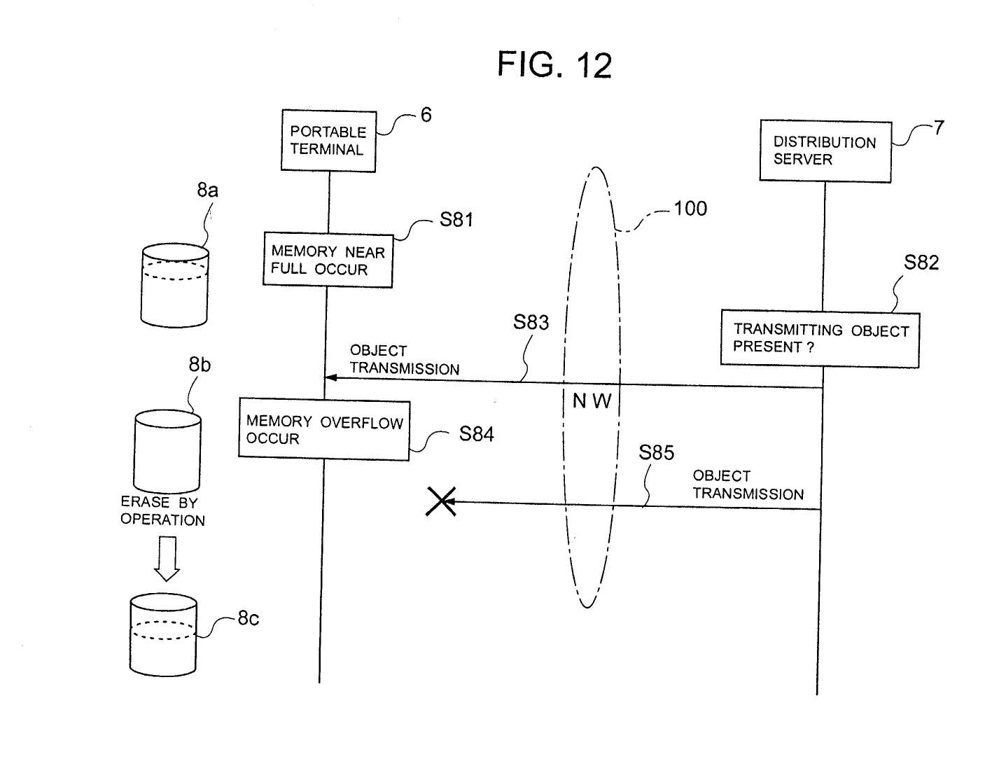

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details.

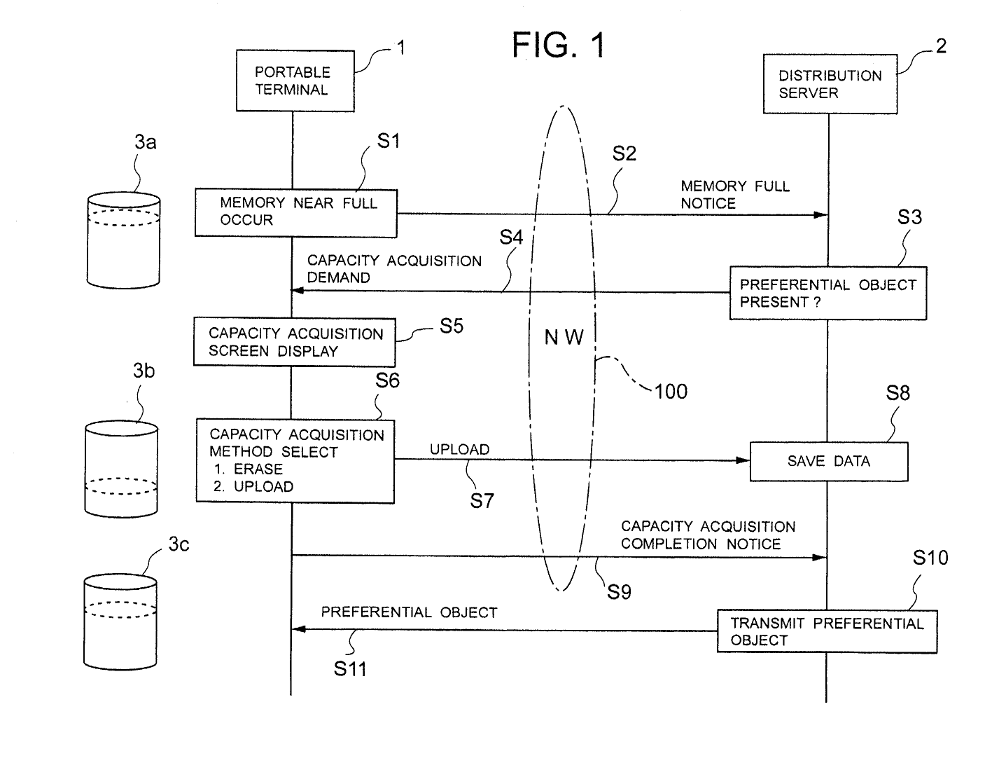

FIG. 1 is a sequence chart showing operation of the first embodiment of an object distribution system according to the present invention. Operation of the first embodiment of the object distribution system according to the present invention will be discussed with reference to FIG. 1.

When a portable terminal 1 becomes a condition where a capacity of a storage medium 3 (which is general representation of storage media 3a to 3c), such as built-in or external memory or the like, is near full (condition of the storage medium 3a of FIG. 1) (S1 of FIG. 1), a memory full notice S2 is transmitted to a distribution server 2.

In the distribution server 2, if there is an object to be given preference at this time (S3 of FIG. 1), a capacity acquiring demand S4 is transmitted to the portable terminal 1 to promote acquiring of capacity of the storage medium 3 to the portable terminal 1.

In response to the capacity acquiring demand S4 in the portable terminal 1, a capacity acquiring screen is displayed (S5 of FIG. 1) for requiring selection of measure, i.e. erasure or uploading, to be taken by an user of the portable terminal and selection of an object to be erased or uploaded are performed (S6 of FIG. 1). When selection is completed and the selected measure is uploading to save in the distribution server 2, the selected object is transmitted to the distribution server 2 (S7 of FIG. 1).

When uploading is completed and the object is stored in the distribution server 2 (S8 of FIG. 1), the portable terminal 1 transmits a capacity acquisition completion notice message S9 to the distribution server 2 (condition of the storage medium 3b of FIG. 1).

When vacancy in capacity in the storage medium 3 of the portable terminal 1 is recognized, the distribution server 2 transmits the object Sll to be given preference to the portable terminal 1 (S10 of FIG. 1) (condition of the storage medium 3c of FIG. 1).

As set forth above, by demanding memory necessary for distribution of the object from the distribution server 2 to the portable terminal 1, acquisition of the capacity is performed on the side of the portable terminal 1. Therefore, even when the object to be preferentially transmitted is present, such preferential object can be transmitted from the distribution server 2 to the portable terminal 1.

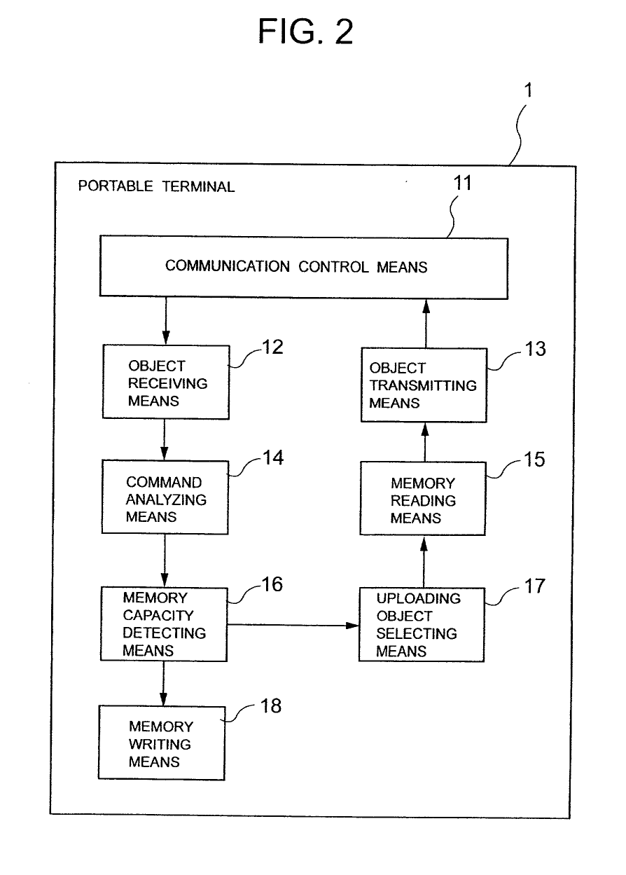

FIG. 2 is a block diagram showing a construction of the portable terminal 1 of FIG. 1. In FIG. 2, the portable terminal 1 is constructed with communication control means 11, object receiving means 12, object transmitting means 13, command analyzing means 14, memory reading means 15, memory capacity detecting means 16, uploading object selecting means 17 and memory writing means 18.

The communication control means 11 performs communication with the distribution server 2 through a wired or radio network 100. The object receiving means 12 and the object transmitting means 13 performs transmission and reception of the object with the distribution server 2. The command analyzing means 14 analyzes commands transmitted from the distribution server 2 to notify a result to other module (other means).

The memory capacity detecting means 16 detects capacity of the storage medium 3 to notify to other module (other means). The memory writing means 18 and the memory reading means 15 perform writing and reading of object to and from the storage medium 3, respectively. The uploading object selecting means 17 selects object for temporarily uploading to the distribution server 2.

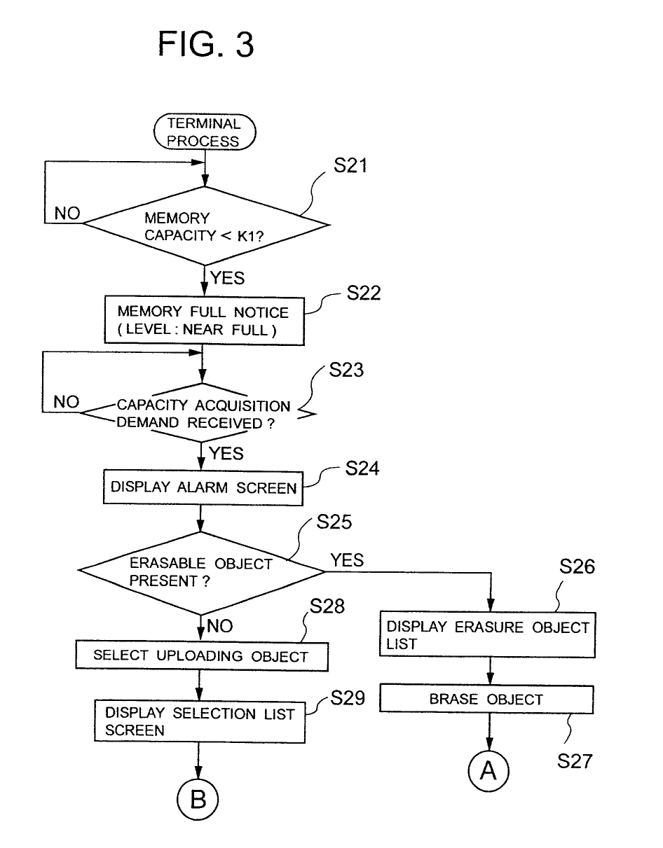

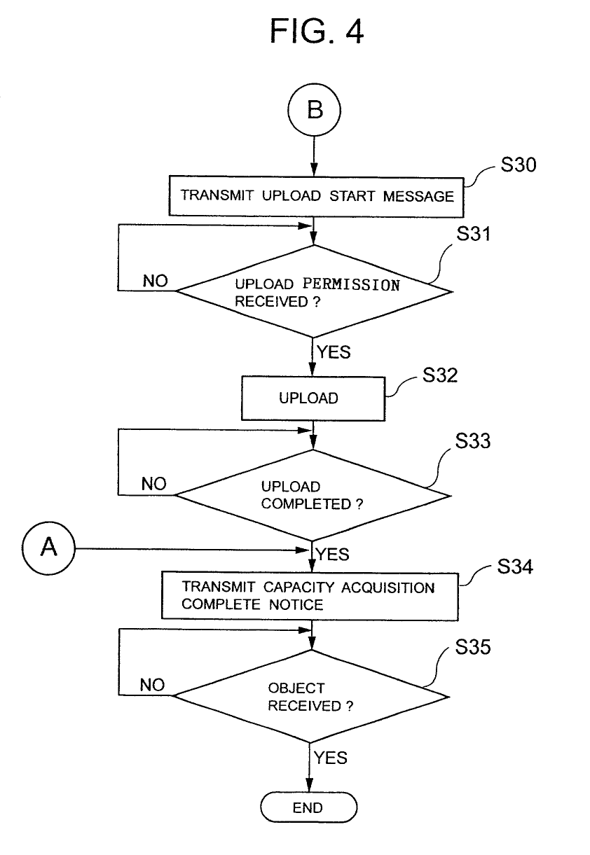

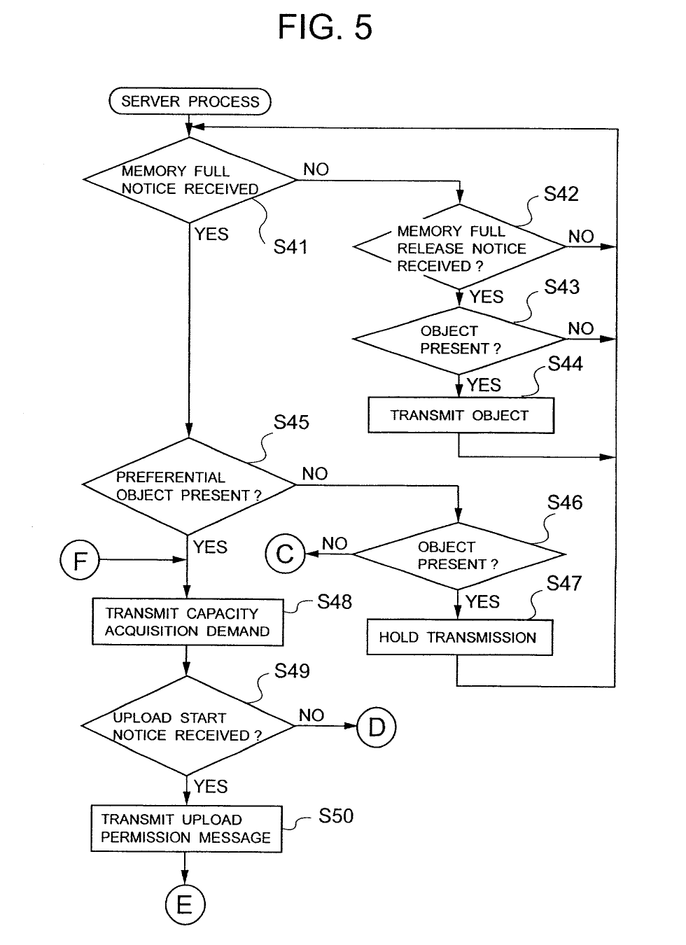

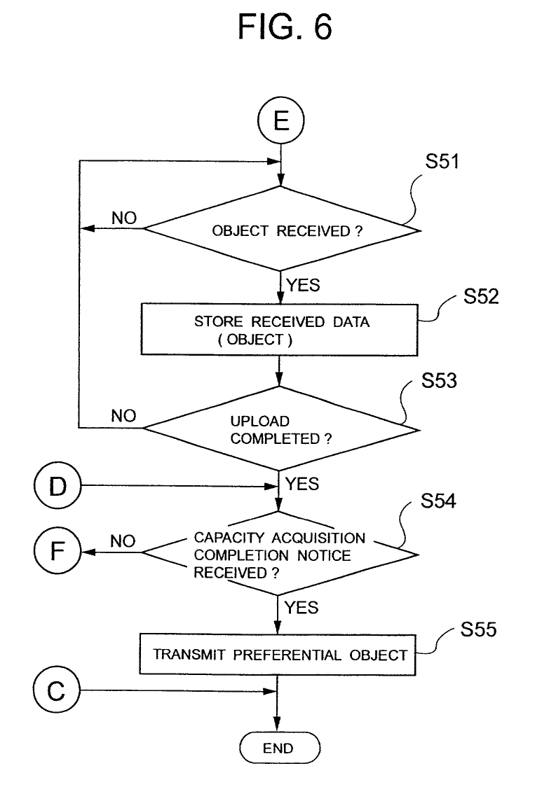

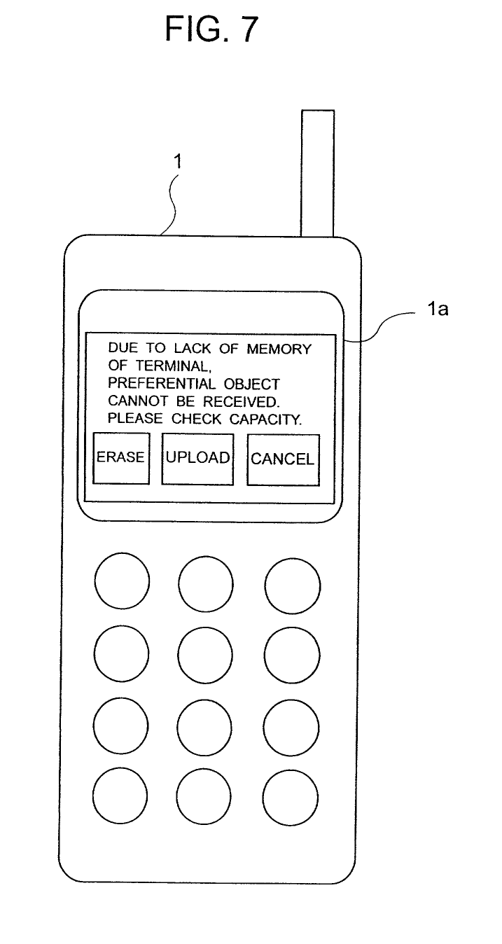

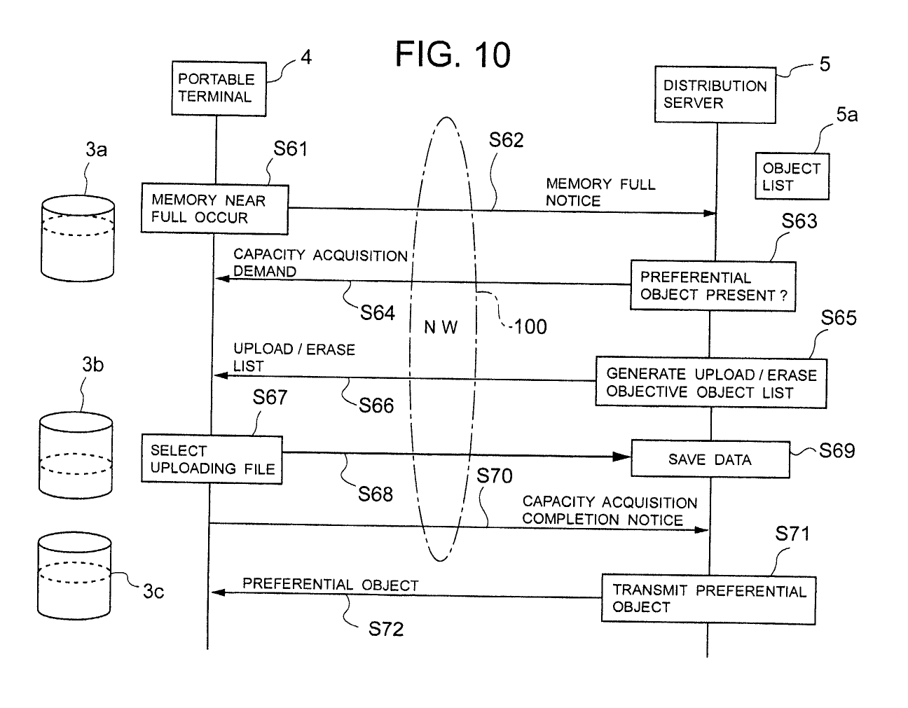

FIGS. 3 and 4 are flowcharts showing process operation of the portable terminal 12 of FIG.1. FIGS.5 and 6 are flowcharts showing process operation of the distribution server 2 of FIG. 1. FIGS. 7 to 9 are illustrations showing display screens of the portable terminal of FIG. 1. FIG. 10 is an illustration showing a list of data to be uploaded to the distribution server 2 of FIG. 1. Operation of the first embodiment of the object distribution system of the present invention will be discussed with reference to FIGS. 1 to 10.

The first embodiment of the object distribution system according to the present invention is constructed with the portable terminal 1 having a function for communication in wire or radio and storage medium 3, such as memory or card type storage medium or the like capable of storing the object and the distribution server 2 capable of storing objects, such as electronic mails, WEB data and so forth transmitted from internet and distributing to the portable terminal 1, and temporarily storing object from the portable terminal 1.

After storing the object, the portable terminal 1 always checks capacity of the storage medium 3. When the capacity of the portable terminal 1 becomes less than a threshold value (here defined as K1) (step S21 of FIG. 3), a memory full notice message S2 indicative of a condition near memory full (hereinafter referred to as memory near full condition) is transmitted o the distribution server 2 (step S22 of FIG. 3). Under a condition where memory full notice S12 has already been sent to the distribution server 2, if a capacity of the storage medium 3 becomes greater than or equal to K1, the portable terminal transmits a memory full release notice to the distribution server 2.

In the memory full notice message S2 and the memory full release message, ID (identification information) identifying the portable terminal 1, the message identification and a code indicative of a level of remaining capacity are contained. For example, code indicative of the remaining capacity of the storage medium 3 is “1” when the remaining capacity is less than 1 Kbytes, “2” when the remaining capacity is greater than or equal to 1 Kbytes and less than 10 Kbytes, “3” when the remaining capacity is greater than or equal to 10 Kbytes and less than 100 Kbytes, and “4” when the remaining capacity is greater than or equal to 100 Kbytes. For other example, the remaining capacity may be contained in the code, as it is.

In the distribution server 2, when memory full condition of the portable terminal 1 is recognized with the received memory full notice S2, and if there is the object to be given preference (S3 of FIG. 1), the capacity acquisition demand message S4 is transmitted to the portable terminal 1 to promote acquisition of the capacity of the storage medium 3 for the portable terminal 1.

When the portable terminal 1 is responsive to the capacity acquisition demand message S4 from the distribution server 2 (step S23 of FIG. 3), at first, display indicating that preferential object cannot be received due to lack of memory (step S24 of FIG. 3) to require to the user of the portable terminal to erase selected object(s) among objects stored in the storage medium 3 or to temporarily upload the selected object(s) (S6 of FIG. 1) (step S25 of FIG. 3), as shown in a terminal screen 1a of FIG. 7.

At this time, in the portable terminal 1, presence of preferential object in the distribution server 2 can be known by reception of the capacity acquisition demand message S4. The preferential object is the object required to be transmitted the portable terminal 1 within a period as short as possible. Size and kind of the preferential object are added to the capacity acquisition demand message S4.

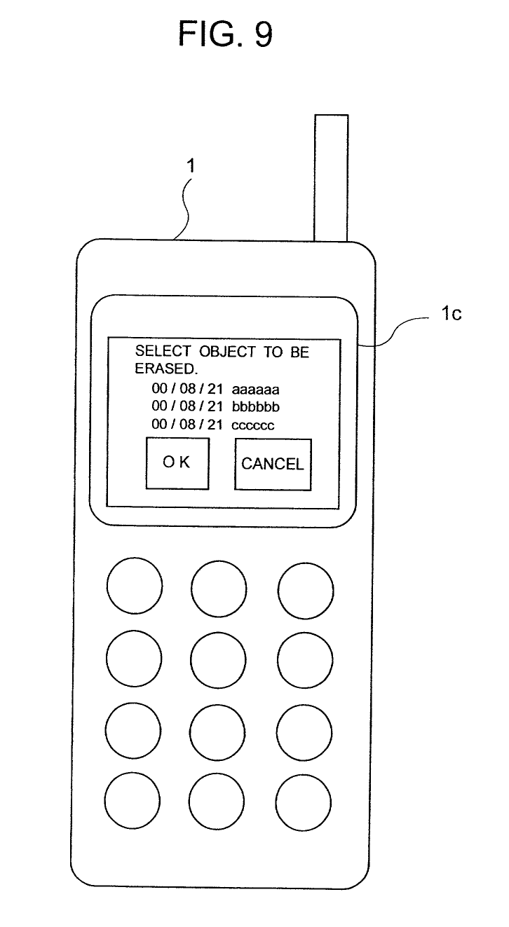

When the user of the portable terminal selects erasure of the object, as shown in the terminal screen 1c of FIG. 9, the data list stored in the portable terminal 1 is displayed for selecting the object for erasure (step S26 of FIG. 3). When the user of the portable terminal completes selection of the object, the portable terminal 1 erases the selected object (step S27 of FIG. 3) to transmit the capacity acquisition completion notice S9 for the distribution server 2 (step S34 of FIG. 4).

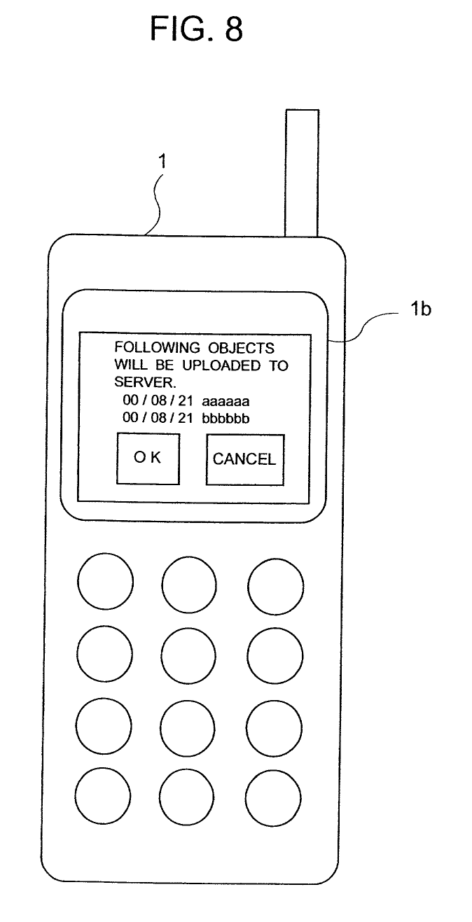

When the user of the portable terminal selects uploading, as shown in a terminal screen 1b of FIG. 8, the portable terminal 1 displays data list to be uploaded to the distribution server 2 (steps S28 and S29 of FIG. 3). As object to be uploaded to the distribution server 2, (1) object having old access history and being not accessed within a determined time and day, (2) object already accessed and (3) object having low preference preliminarily set by the user of portable terminal, such as WEB data, mail data, business file and so forth which are not required to maintain in the portable terminal. Preferences of respective objects may be selected by the user of the portable terminal.

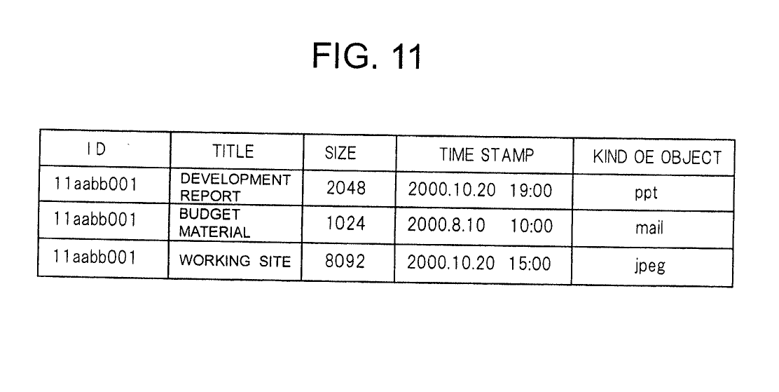

The list of data for uploading to the distribution server 2 is stored in the portable terminal 1 and is used for downloading from the distribution server 2. As shown in FIG. 11, content of the list includes ID (identifier) of the object, title, object size, time stamp, kind of object, such as mail and so on.

When the user confirms the content on the terminal screen 1b, the portable terminal 1 transmits an upload start message to the distribution server 2 (step S30 of FIG. 4). Upon reception of an uploading permission message from the distribution server 2 (step S31 of FIG. 4), the portable terminal 1 starts uploading (S7 of FIG. 1) (step S32 of FIG. 4).

When uploading is completed (step S33 of FIG. 4), the portable terminal 1 transmits a capacity acquisition completion notice S9 for the distribution server 2 (step S34 of FIG. 4). Subsequently, the preferential object is transmitted from the distribution server 2 (S11 of FIG. 1).

By erasure or the like of received object in the portable terminal 1 by the user and vacancy greater than or equal to a given amount is formed in the capacity of the storage medium 3, the portable terminal transmits the memory full release notice to the distribution server 2.

When the user accesses the uploaded object by the portable terminal 1, the portable terminal 1 transmits an object acquisition demand corresponding to the portable terminal 1 to the distribution server 2. In the distribution server 2, the corresponding object is transmitted to the portable terminal 1.

On the other hand, when the memory full notice is received from the portable terminal 1 (step S41 of FIG. 5), the distribution server 2 at first checks whether the preferential object for the portable terminal 1 is present or not (step S45 of FIG. 5). When the preferential object is not present, the distribution server 2 checks whether normal objects (having normal level preference) is present or not (step S46 of FIG. 5). If the normal object is present, the distribution server 2 performs holding of transmission of the object (step S47 of FIG. 5). If the normal object is not present, process is terminated.

On the other hand, if the preferential object is present, the distribution server 2 transmits the capacity acquisition demand S4 added data size and kind of data of the preferential object (step S48 of FIG. 5) and then is placed in a waiting state for waiting message from the portable terminal 1.

Upon reception of the uploading start notice from the portable terminal 1 (step S49 of FIG. 5), the distribution server 2 transmits the upload permission message after preparation for reception (step S50 of FIG. 5). Subsequently, the distribution server 2 stores reception of the object transmitted from the portable terminal 1 (steps S51, S52 of FIG. 6).

Upon completion of uploading (step S53 of FIG. 6), when the distribution server 2 receives the capacity acquisition completion notice S9 from the portable terminal 1 (step S54 of FIG. 6), the preferential object Sll is transmitted (step S55 of FIG. 6).

When the capacity is acquired by erasing the object on the side of the portable terminal 1, the upload start notice is not transmitted from the portable terminal 1 and the capacity acquisition completion notice S9 is transmitted from the portable terminal 1.

When the memory full release notice is received from the portable terminal 1 (step 42 of FIG. 5), if the object held in transmission is present (step S43 of FIG. 5), the distribution server 2 performs transmission of object to the portable terminal 1 (step S44 of FIG. 5).

On the other hand, when the object acquisition demand is received from the portable terminal 1, the distribution server 2 makes judgment whether a volume of the relevant object can be received by the portable terminal 1 or not and then transmits the object to the portable terminal 1 which can receive the object.

As set forth above, when the storage medium 3 of the portable terminal 1 is in full condition and when the object having high preference on the distribution server 2 is desired to be received by the portable terminal 1, the objects stored in the storage medium 3 is temporarily uploaded to the distribution server 2 to save therein to enable reception of the object having high preference on the distribution server 2 without erasing the object stored in the portable terminal 1.

On the other hand, since object size of the intended object is transmitted from the distribution server 2, a size necessary for storing the object can be known on the side of the portable terminal 1 in advance, a storage region of the storage medium 3 can be released efficiently.

Furthermore, when the capacity of the storage medium 3 becomes full, the memory full condition is noticed to the distribution server 2 from the portable terminal 1. Therefore, wasteful communication between the portable terminal 1 and the distribution server 2 becomes unnecessary.

FIG. 10 is a sequence chart showing operation of the second embodiment of the object distribution system according to the present invention. Operation of the second embodiment of the object distribution system according to the present invention will be discussed with reference to FIG. 10.

The second embodiment of the object distribution system according to the present invention is differentiated from the first embodiment of the object distribution system according to the present invention in that when the memory of the portable terminal 1 is in a full condition, the file to be uploaded or erased by the portable terminal 1 is determined by the distribution server 5, and list of the files to be uploaded or erased is transmitted from the distribution server 2 to the portable terminal 1 for selecting the files to be uploaded or erased by the portable terminal 1.

Upon storing the objects, such as electronic mail data, WEB data and so forth, transmitted from the internet per user, the distribution server 5 holds list of the content of the objects per user (object list 5a). The content of the object list 5a includes ID for identifying the object, title, object size, time stamp of the object as obtained in the distribution server 5, kind of the object, such as mail or the like, as shown in FIG. 11.

The portable terminal 4 is responsive to occurrence of the condition near memory full of the storage medium 3 (storage medium 3a of FIG. 10) (S61 of FIG. 10), a memory full notice S62 is transmitted to the server 5.

When the object required preferential distribution is present on the server 5 (S63 of FIG. 10), the distribution server 5 transmits a capacity acquisition demand S64 to the portable terminal 4 and to generates upload/erase list for object size necessary for distribution (S65 of FIG. 10) to transmit the upload/erase list 66 to the portable terminal 4. Generation of the upload/erase list S66 is performed under the condition set forth above.

In the portable terminal 4, file to upload is decided on the basis of the upload/erase list S66 (S67 of FIG. 10) and performs uploading of the selected file to the distribution server 5 (S68 of FIG. 10). The distribution server 5 stores the files (S69 of FIG. 10).

Subsequently, the portable terminal 4 transmits the capacity acquisition completion notice S70 to the server 5. In the server 5, the capacity of the storage medium 3 on the side of the portable terminal 4 recognized acquisition of the capacity, and transmission of the preferential object S72 is started (S71 of FIG. 10).

As set forth above, similarly to the first embodiment, when the object having high preference on the server 5 is desired to receive when the storage medium 3 of the portable terminal 4 is in full condition, the object having high preference on the distribution server 5 can be received without erasing the objects stored in the portable terminal 4 by temporarily saving the objects in the storage medium 3 designated by the distribution server 5.

On the other hand, since the object size of the object intended to be distributed is transmitted from the distribution server 5, a size or capacity of the intended object can be seen on the side of the portable terminal 4 in advance, the storage region in the storage medium 3 can be released efficiently.

Furthermore, when the capacity of the storage medium 3 of the portable terminal 4 becomes full, the memory full notice is sent to the distribution server 5 to eliminate wasteful transmission between the portable terminal 4 and the distribution server 5.

As set forth above, according to the present invention, in the object distribution system, in which the portable terminal and the distribution server distributing the object to the portable terminal, when the remaining capacity of the storage medium of the portable terminal which can be written the object becomes less than or equal to the preliminarily set threshold value, the message indicative of the memory full condition is noticed from the portable terminal to the distribution server, acquisition of capacity of the memory for receiving the object can be achieved without wasteful distribution or memory erasure by the user.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An object distribution system, in which a portable terminal and a server for distributing an object to said portable terminal, are connected by a network, said portable terminal comprising:
a storage medium for storing said object;
detecting means for detecting a remaining capacity of said storage medium becoming less than or equal to a preliminarily set threshold value; and
transmitting means for transmitting a message for notifying a memory full condition of said storage medium to said server when said detecting means detects the remaining capacity of said storage medium becoming less than or equal to said threshold value.

2. An object distribution system as set forth in claim 1, wherein said server includes means for notifying a demand message promoting acquisition of capacity of said storage medium to said portable terminal when said server receives said message and holds an object for transmitting to said portable terminal.

3. An object distribution system as set forth in claim 2, wherein at least a data size and a kind of data of said object is added to said demand message.

4. An object distribution system as set forth in claim 2, wherein when said portable terminal receives said demand message, a message promoting acquisition of capacity of said storage medium is displayed on a display screen of said portable terminal.

5. An object distribution system as set forth in claim 1, wherein upon acquisition of capacity of said storage medium, selection is made for selecting one of temporarily saving of objects stored in said storage in said server and erasure thereof.

6. An object distribution system as set forth in claim 5, wherein the object to be selected upon acquisition of capacity of said storage medium is one having recent access history indicating expiration of a given period from last access.

7. An object distribution system as set forth in claim 5, wherein the object to be selected upon acquisition of capacity of said storage medium is performed at least based on kind of said object.

8. An object distribution system as set forth in claim 2, wherein when a storage region for said preferential object is acquired in said storage medium, a message indicative of capacity acquisition completion of said storage medium is transmitted to said server from said portable terminal.

9. An object distribution system as set forth in claim 1, wherein said server comprises a list of objects transmitted to said portable terminal and transmits a list of objects to be uploaded from said portable terminal when said server demands acquisition of capacity of said storage medium for said portable terminal.

10. A memory management method in a portable terminal in an object distribution system, in which a portable terminal and a server for distributing an object to said portable terminal, are connected by a network, said method comprising:
step of detecting a remaining capacity of a storage medium for storing said object, becoming less than or equal to a preliminarily set threshold value; and
step of transmitting a message for notifying a memory full condition of said storage medium to said server when said detecting means detects the remaining capacity of said storage medium becoming less than or equal to said threshold value.

11. A memory management method as set forth in claim 10, wherein said server includes means for notifying a demand message promoting acquisition of capacity of said storage medium to said portable terminal when said server receives said message and holds an object for transmitting to said portable terminal.

12. A memory management method as set forth in claim 11, wherein at least a data size and a kind of data of said object is added to said demand message.

13. A memory management method as set forth in claim 11, wherein when said portable terminal receives said demand message, a message promoting acquisition of capacity of said storage medium is displayed on a display screen of said portable terminal.

14. A memory management method as set forth in claim 10, wherein upon acquisition of capacity of said storage medium, selection is made for selecting one of temporarily saving of objects stored in said storage in said server and erasure thereof.

15. A memory management method as set forth in claim 14, wherein the object to be selected upon acquisition of capacity of said storage medium is one having recent access history indicating expiration of a given period from last access.

16. A memory management method as set forth in claim 14, wherein the object to be selected upon acquisition of capacity of said storage medium is performed at least based on kind of said object.

17. A memory management method as set forth in claim 11, wherein when a storage region for said preferential object is acquired in said storage medium, a message indicative of capacity acquisition completion of said storage medium is transmitted to said server from said portable terminal.

18. A memory management method as set forth in claim 10, wherein said server comprises a list of objects transmitted to said portable terminal and transmits a list of objects to be uploaded from said portable terminal when said server demands acquisition of capacity of said storage medium for said portable terminal.

19. A portable terminal to be connected to a server for distributing an object through a network, comprising:
a storage medium for storing said object;
detecting means for detecting a remaining capacity of said storage medium becoming less than or equal to a preliminarily set threshold value; and
transmitting means for transmitting a message for notifying a memory full condition of said storage medium to said server when said detecting means detects the remaining capacity of said storage medium becoming less than or equal to said threshold value.

20. A portable terminal as set forth in claim 19, wherein when a demand message promoting capacity acquisition of said storage medium is received, the demand message is displayed on a display screen.

21. A portable terminal as set forth in claim 19, wherein upon acquisition of capacity of said storage medium, selection is made for selecting one of temporarily saving of objects stored in said storage in said server and erasure thereof.

22. A portable terminal as set forth in claim 21, wherein the object to be selected upon acquisition of capacity of said storage medium is one having recent access history indicating expiration of a given period from last access.

23. A portable terminal as set forth in claim 21, wherein the object to be selected upon acquisition of capacity of said storage medium is performed at least based on kind of said object.

24. A portable terminal as set forth in claim 20, wherein when a storage region for said preferential object is acquired in said storage medium, a message indicative of capacity acquisition completion of said storage medium is transmitted to said server from said portable terminal.

25. A server connected to a portable terminal through a network for distributing an object, comprising:
means for receiving a message notifying a memory full condition of a storage medium which can be written said object, from said portable terminal and notifying a demand message promoting capacity acquisition of said storage medium for said portable terminal upon holding an object to be transmitted to said portable terminal.

26. A server as set forth in claim 25, wherein at least a data size and a kind of data of said object is added to said demand message.

27. A server as set forth in claim 25, which comprises a list of objects transmitted to said portable terminal and transmits a list of objects to be uploaded from said portable terminal when said server demands acquisition of capacity of said storage medium for said portable terminal.
